(19) United States
(12) Patent Application Publication
(10) Pub. No.: US 2024/0296261 A1
(43) Pub. Date: Sep. 5, 2024

(54) POWER SYSTEM MODEL CALIBRATION USING MEASUREMENT DATA

(71) Applicant: Siemens Corporation, Washington, DC (US)

(72) Inventors: Suat Gumussoy, Princeton, NJ (US); Xiaofan Wu, North Brunswick, NJ (US); Ulrich Muenz, Princeton, NJ (US)

(73) Assignee: Siemens Corporation, Washington, DC (US)

(21) Appl. No.: 18/550,469

(22) PCT Filed: Sep. 29, 2021
(86) PCT No.: PCT/US2021/052503

§ 371 Date: Sep. 14, 2023

Related U.S. Application Data
(60) Provisional application No. 63/181,992, filed on Apr. 30, 2021.

(51) Int. Cl. G06F 30/20; H02J 3/38

(52) U.S. Cl. CPC G06F 30/20; H02J 3/38; H02J 2203/20

(57) ABSTRACT

A computer-implemented method for online calibration of power system model against a power system includes iteratively approximating the power system model, at sequential optimization steps, around a moving design point defined by parameter values of a set of calibration parameters of the power system model. At each optimization step, an approximated system model is used to transform a dynamic input signal into a model output signal, which is compared with measurement signals obtained from measurement devices installed in the power system that define an actual power system output signal generated in response to the dynamic input signal. Parameter values of the calibration parameters adjusted in a direction to minimize an error between the model output signal and the actual power system output signal. The power system model is calibrated against the power system based on resulting optimal values of the calibration parameters.

### STATEMENT REGARDING FEDERALLY SPONSORED DEVELOPMENT

Development for this invention was supported in part by Subaward Agreement No: DE-AR0001062, awarded by Advanced Research Projects Agency—Energy (ARPA-E) that operates under the U.S. Department of Energy. Accordingly, the United States Government may have certain rights in this invention.

### TECHNICAL FIELD

The present disclosure relates to validation and calibration of power system models for increased reliability of power system models for operational decisions.

### BACKGROUND

Present day power systems have become dynamic and stochastic with the ever-increasing penetration of renewable energy, electrical vehicles and impacts from climate changes. Power system operators heavily rely on accurate power system models to determine appropriate planning and real-time control actions. Periodically validating stability models, for example, of generators, exciters, governors and power system stabilizers, is therefore of critical importance to power system operators.

Traditionally, power system model validation and parameter calibration have been implemented using staged testing. While effective and sufficiently accurate for establishing a power plant's models, this approach is very costly and labor intensive, because the generator being tested needs to be taken offline. As a low-cost alternative, model validation and parameter calibration can be implemented in an online mode without taking the generator offline.

A goal of model calibration practice is to reduce the discrepancy between the model and actual system behavior. Online model validation and parameter calibration involves injecting measurement signals, such as voltage magnitude and frequency/phase angle, into the power plant terminal bus during the dynamic simulation so one can compare a model's response to actual measurements obtained from the power system. This simulation method to validate the model is called ‘event playback’ and the injected measurements are called ‘play-in signals’.

Many currently known methods for state estimation and parameter calibration are based on using a Kalman filter or its variants. An example approach is described in the publication [1]: Renke Huang, Ruisheng Diao, Yuanyuan Li, Juan Sanchez-Gasca, Zhenyu Huang, Brian Thomas, Pavel Etingov et al. “Calibrating parameters of power system stability models using advanced ensemble Kalman filter.” IEEE Transactions on Power Systems 33, no. 3 (2017): 2895-2905. Other known approaches include non-linear curve fitting techniques, simultaneous perturbation stochastic approximation-based particle swarm optimization, feature based search, dynamic state-estimation-based generator parameter identification algorithm, rule-based approach, using Bayesian inference framework, deep reinforcement learning, among others.

State-of-the-art methods, such as that mentioned above, can be computationally intense, and may pose other challenges, such as existence of multiple solutions, poor convergence or precision, difficulty scaling to power systems having large number of generators, etc.

### SUMMARY

Briefly, aspects of the present disclosure provide an improved technique for online calibration of a power system model using actual measurement data obtained from the power system, that addresses at least some of the technical challenges mentioned above.

A first aspect of the disclosure sets forth a computer-implemented method for online calibration of a power system model against an actual power system. The power system comprises one or more active generator subsystems connected to a power network and a number of measurement devices installed in the power network to dynamically measure electrical quantities associated with each of the active generator subsystems. The method comprises iteratively performing a series of steps, where each step comprises executing a model approximation engine by one or more processors to generate a system model that approximates the power system model, based on current parameter values of a set of model calibration parameters. Each step further comprises executing a model validation engine by the one or more processors to: use the generated system model to transform a dynamic input signal into a model output signal, and to obtain measurement signals from the measurement devices that define an actual power system output signal generated in response to the dynamic input signal. Each step further comprises executing a sequential optimization engine by the one or more processors to adjust parameter values of the model calibration parameters in a direction to minimize an error between the model output signal and the actual power system output signal. The power system model is calibrated against the power system based on resulting optimal values of the model calibration parameters.

According to a further aspect of the disclosure, the power system model, which is calibrated by a method as described above, is used to control a power system. The calibrated power system model is used to run simulations to predict a response of the power system to one or multiple input scenarios. One or more generator subsystems of the power system are controlled via controllers of the generator subsystems by generating control actions determined on the basis of the simulations using the calibrated power system model.

Other aspects of the disclosure implement features of the above-described methods in computer program products and computing systems for model calibration.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 is a schematic diagram of a power system including an online model calibration system according to an example embodiment.

FIG. 2 is a schematic diagram illustrating portion of a modeled power system that includes a generator subsystem.

FIG. 3 is a schematic diagram illustrating selection of calibration parameters by a sensitivity analysis engine according to an exemplary embodiment.

FIG. 4 is a process flow diagram illustrating a model calibration method according to an exemplary embodiment.

FIG. 5 shows an example of a computing system that supports online calibration of a power system model according to aspects of the present disclosure.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

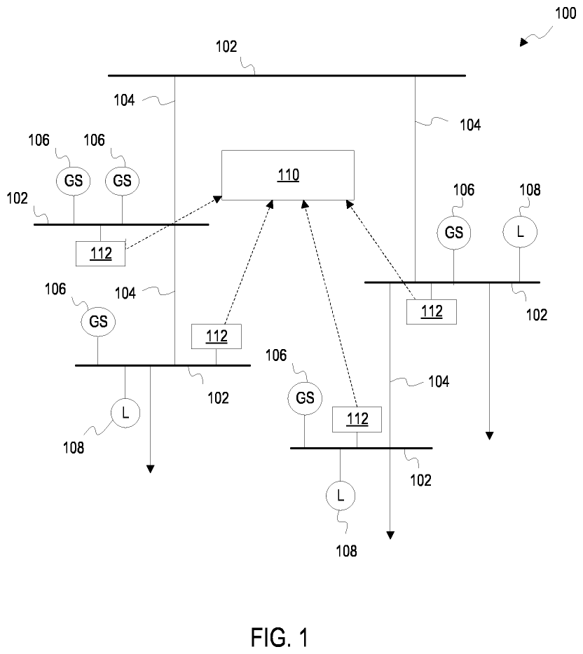

Turning now to the drawings, FIG. 1 illustrates an example of a power system 100 wherein aspects of the present disclosure may be implemented. The power system 100 includes a power network formed by a plurality of nodes or buses 102 connected by branches or power lines 104. The shown topology of the power network is illustrative and simplified. The disclosed methodology is not limited to any particular type of network topology. As shown, some of the nodes 102 may have one or more generator subsystems 106 and/or loads 108 connected to them. The generator subsystems 106 may include conventional power plants, but may also include distributed energy resources (DER) such as wind parks, photovoltaic panels, etc.

A power system operator, such as a utility company, may utilize a power system model of the power system 100 to determine appropriate planning and real time control actions. The power system model may form part of a digital twin of the power system 100. The power system model may be built, for example, using commercial software tools, such as PSS®E, developed by Siemens AG, PSLF® developed by General Electric Company, among many others. Integrity of the power system model can be key to reliable and economical delivery to power consumers, because long-term or mid-term planning and operational decisions often reply on static and dynamic simulation executed using the power system model. One of the challenges associated with the model-based simulation is a discrepancy between the power system model output and actual power system behavior in response to the same input signal. Often, this discrepancy arises due to inaccuracies in the model parameters used in the power system model.

As shown in FIG. 1, the power system 100 includes a model calibration system 110 to calibrate the power system model against the power system 100. The model calibration system 110 is configured to calibrate model parameters of the power system model using online measurement data from the power system 100 based on the methodology described herein. To that end, the model calibration system 110 may communicate with measurement devices 112 installed at various locations in the power network to measure electrical quantities, such as voltage, frequency, active power, reactive power, etc., associated with active (connected) generator subsystems 106. As shown, each individual measurement device 112 may be configured to carry out online measurements of the electrical quantities for one or multiple generator subsystems 106.

In one suitable implementation, one or more of the measurement devices 112 may comprise phasor measurement units. A phasor measurement unit (PMU) is a measurement device used to estimate the magnitude and phase angle of an electrical phasor quantity, such as voltage or current, in the electricity grid, with a common time source for synchronization. A typical commercial PMU can record measurements with high temporal resolution, up to about 120 samples per second. Such high-resolution data is very useful for calibration of power system models. The disclosed methodology is, however, not limited to a specific type of measurement device.

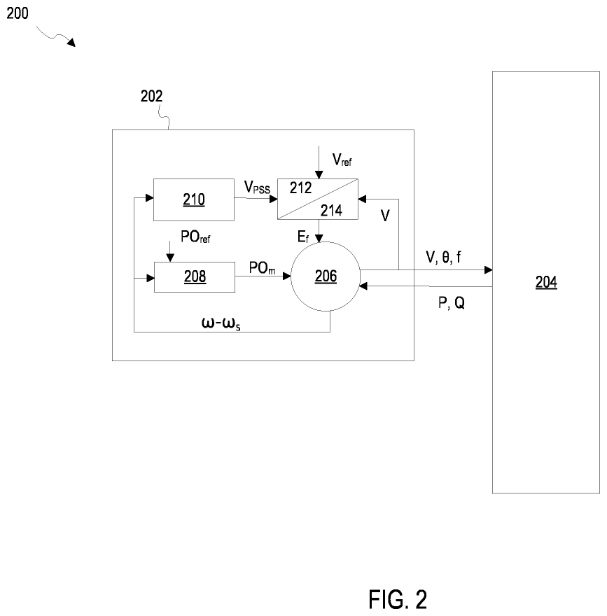

FIG. 2 illustrates portion of a modeled power system 200 showing in detail a modeled internal structure of a generator subsystem 202 connected to a power network 204. It is to be noted that the described modeling is merely an example and not meant to be limiting. A generator subsystem may comprise a generator and one or more controllers. In the shown example, the generator subsystem includes a synchronous generator 206 and controllers that include a governor 208, a power system stabilizer 210, an exciter 212 and an automatic voltage stabilizer 214. A detailed description of the modelling is available in the publication [2]: Amer Mešanović, Ulrich Münz, Joachim Bamberger, and Rolf Findeisen. “Controller tuning for the improvement of dynamic security in power systems.” In 2018 IEEE PES Innovative Smart Grid Technologies Conference Europe (ISGT-Europe), pp. 1-6. IEEE, 2018.

Briefly described, the governor 208 controls the mechanical power output POₘ of the prime mover (e.g., a turbine) into the generator 206 based on the angular velocity of the generator 206. The power system stabilizer 210 receives the deviation from nominal frequency ω-ωₛ input to produce an output V_{PSS} that is configured to improve the small signal stability of the generator subsystem 202. The inputs to the exciter 212 are the reference voltage V_{ref}, the generator terminal voltage V and the input V_{PSS} from the power system stabilizer 210. The output of the exciter 212 is a field winding voltage E_{f}. The automatic voltage regulator 214 controls the field winding voltage E_{f} produced by the exciter 212 to regulate the terminal voltage V of the generator 206. The measurable quantities include the terminal voltage V, angle θ of the voltage phasor, frequency f, active power P and reactive power Q.

The model parameters of the power system model may include a set of controller parameters, such as gains, damping coefficients, time constants, etc. associated with the governor 208, power system stabilizer 210, exciter 212 and automatic voltage regulator 214 of various generator subsystems, for example, as identified in the publication [2]. The model parameters may additionally include physical parameters associated the generator subsystems, such as parameters indicative of size, inertia and design (e.g., number of generator poles, number of turns in winding, and so forth) of components such as turbine, shaft, generator, etc. The set of controller parameters and physical parameters are collectively referred to herein as system parameters.

The power system model of the power system 100 may be initially established, for example, from data obtained from staged testing (among other methods), in which engineers may run certain tests on individual generator subsystems 106 (e.g., power plants) to determine the values of system parameters that mathematically characterize the behavior of the power system 100. These values can then be used in the creation of the power system model. The power system model may give an accurate representation of the behavior of generator subsystems 106 as they interact with the power network. However, the originally used values of the system parameters may change as conditions in the power plants change, for example, when equipment is added or replaced. It is desirable, and often required, to keep the power system model current by periodic validation and calibration.

The disclosed methodology provides a technique for online calibration of system parameters, that can include controller parameters and/or physical parameters of the modeled power system, typically both, based on measurement data. The power system model can include a non-linear system model describing the power system 100. In some embodiments, for model calibration, the existing power system model (e.g., provided as a model in PSS®E) may be converted to a different format (e.g., in Simulink® environment) suitable for carrying out the disclosed methodology. The disclosed methodology starts with an initial or original set of parameter values of the model calibration parameters. The initial or original set of parameter values may include, for example, parameter values currently in use by a power system operator, such as a utility company, in their power system model. Subsequently, over a series of optimization steps, the parameter values are iteratively adjusted by a technique of sequential convex optimization using measurement signals from the measurement devices 112 such that measurement error is minimized.

In accordance with the disclosed methodology, the model calibration system 110 comprises a model approximation engine, a model validation engine and a sequential optimization engine. The model approximation engine generates, at each optimization step, a system model that approximates the power system model, based on current parameter values of a set of model calibration parameters. The model validation engine uses the system model generated at each optimization step to transform a dynamic input signal into a model output signal, and obtains measurement signals from the measurement devices that define an actual power system output signal generated in response to the dynamic input signal. The sequential optimization engine adjusts parameter values of the model calibration parameters, at each optimization step, in a direction to minimize an error between the model output signal and the actual power system output signal. Optimal values of the model calibration parameters are obtained by iteratively executing the steps of model approximation, validation with measurement signals and parameter tuning by sequential optimization, until a convergence criterion is satisfied. The resultant optimal values of the model calibration parameters are transferred to the power system model to calibrate the power system model against the power system.

As illustrated herein, the approximated system model may be generated, at each optimization step, based on a moving design point defined by the current parameter values of the model calibration parameters at that step. In some embodiments, the approximated system model may suitably include a linear system model. The error at each optimization step may be suitably determined based on a frequency domain integral/summation (or alternately, a time domain integral/summation) of the measurement error. The optimization problem may be formulated based on a linear matrix inequality (LMI) with specified constraints.

In the described embodiment, which is exemplary, the error to be minimized is determined as a H₂ norm. The H₂ optimization framework can effectively reduce the input-output noise amplification, which, in this case, is the mismatch between model output signal and measurement signal, in frequency domain. Other implementations may involve using different optimization frameworks for determining a measure of the error, such as using a H_{∞} (H-infinity) optimization framework, among others.

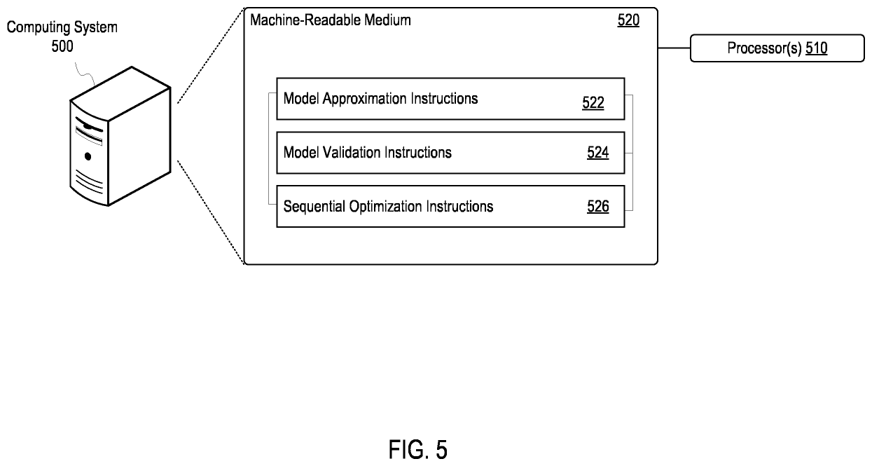

The engines described herein, including components thereof, may be implemented by a computing system in various ways, for example, as hardware and programming. The programming for the engines may take the form of processor-executable instructions stored on non-transitory machine-readable storage mediums and the hardware for the engines may include processors to execute those instructions. An example of a computing system for implementing the described engines is illustrated below referring to FIG. 5.

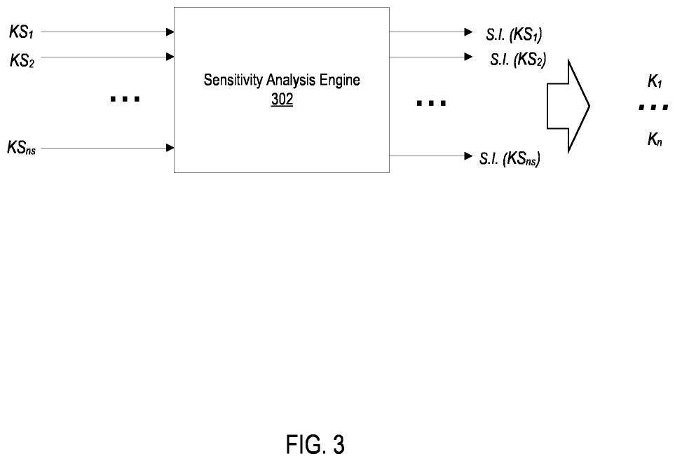

In some embodiments, before calibrating the model parameters, a sensitivity analysis may be carried out to select a subset of highly sensitive parameters out of the set of system parameters as model calibration parameters. As shown in FIG. 3, the model calibration system 110 may optionally include a sensitivity analysis engine 302, which may determine a sensitivity index S.I of individual system parameters KS₁, KS₂, . . . . KSₙₛ, where ns is the size of the system parameter set. Based on the determined sensitivity indices S.I. (KS₁), S.I. (KS₂), . . . . S.I. (KSₙₛ), a small subset of system parameters K₁, . . . Kₙ may be selected as model calibration parameters (i.e., parameters to be calibrated), where n is the size of the model calibration parameter set (n<ns). The sensitivity analysis engine 302 can provide improved quantitative understanding of each system parameter's impact to system dynamic behavior. Sensitivity analysis can ensure that the optimization engine focuses on the parameters which have higher sensitivity index. Optimization complexity can thus be reduced such that the optimization algorithm converges to the optimal parameter values more efficiently.

The sensitivity analysis engine 302 may employ a variety of techniques, including those currently known or available. A commonly used technique is based on a trajectory-sensitivity algorithm, in which a sensitivity level may be determined as a sum of the perturbed input-output ratio of a trajectory. However, this technique may pose a challenge to determine a search range for each system parameter. If the range is too large to be useful for calibration, the sensitivity analysis may not be meaningful. For example, although a system parameter KS, may assume a value within [0, 100], the useful value may be around 1 (local property). In this case, an exploration far away from 1 may be meaningless, even though it may impact the simulation significantly. The algorithm may thus mistakenly take the unstable case as high sensitivity.

According to a disclosed embodiment, the sensitivity analysis engine 302 may determine the sensitivity index of individual system parameters by running simulations using a linear system model of the power system generated for M different values of each system parameter KSᵢ, keeping the remaining system parameters fixed at each instance. The M different values can be distributed within a stable range of the respective system parameter KSᵢ. The sensitivity index (S.I.) at each value (out of the selected M values) of an individual parameter KSᵢ may be determined by measuring an averaged time domain error between a model output Yₗᵢₙₑₐᵣ of the linear system model and an actual power system output Y_{Measured} obtained from the measurement devices, as given by:

$$S . I . = \frac{1}{N} {\sum }_{{T}_{p}}^{p = 1 , 2 , … , N} \vert {Y}_{Measured} ( {T}_{p} ) - {Y}_{linear} ( {T}_{p} ) \vert \qquad ( 1 )$$

where Tₚ denotes time steps, N denotes the total number of time steps, and where Yₗᵢₙₑₐᵣ and Y_{Measured} can include vector representation of quantities such as voltage, frequency, active power, reactive power, etc.

To aid selection of the model calibration parameters, the sensitivity analysis indices determined using eq. (1) may be plotted on a bar figure. The selection may be based on a threshold value of the sensitivity index. Alternately, the number of model calibration parameters to be selected may be predefined (e.g., a fixed number of model calibration parameters for each generator subsystem), such that the parameters with the highest sensitivity index values are selected for calibration.

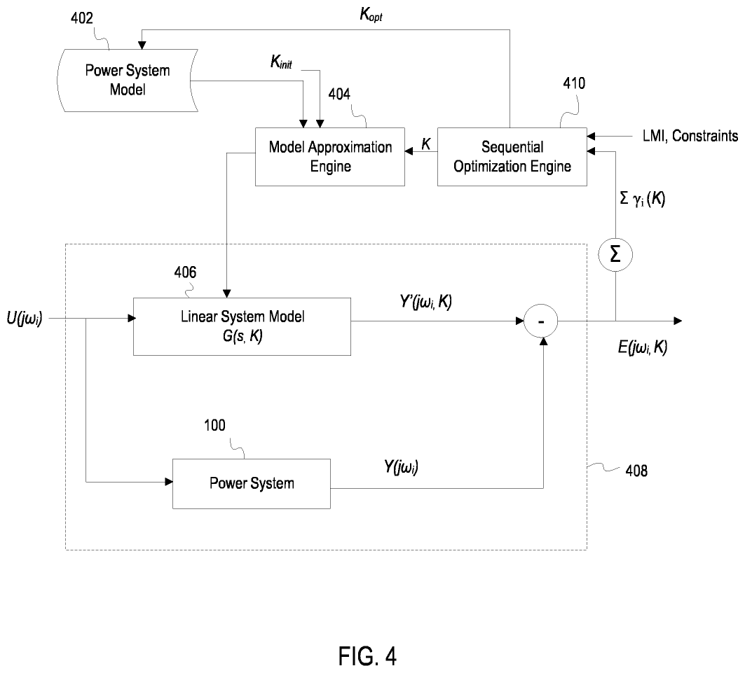

FIG. 4 illustrates an example embodiment of a method executed by a model calibration system, such as the model calibration system 110, to calibrate a power system model 402 against a power system 100, according to aspects of the present disclosure. The described method may be used to calibrate a subset of system parameters that are identified as highly sensitive parameters using a sensitivity analysis engine, for example, as described above. In some embodiments, the sensitivity analysis step may be obviated, and the described method may be executed to calibrate the complete set of system parameters. For the sake of clarity, the set of parameters calibrated using the described method (with or without sensitivity analysis) are referred to herein as model calibration parameters, represented by a vector K.

Referring to FIG. 4, the power system model 402 may include a non-linear system model describing the power system 100. In a non-limiting example implementation, the power system model 402 may be derived as an electro-magnetic-transient (EMT) model of the power system 100 in a Simulink® environment (e.g., SimPowerSystems®). The non-linear power system model 402 may be generally represented as:

$$\dot{x} = f ( x , u , K ) \qquad ( 2 a )$$

$$0 = h ( x , u , K ) \qquad ( 2 b )$$

where x denotes system state (e.g., combined power plant states), u denotes an input signal including all reference values, loads and disturbances, f describes power system dynamics and h represents power flow equations of the power system model 402.

At each optimization step Sₖ, the model approximation engine 404 may be executed to generate a system model approximating the power system model 402 as a function of K, i.e., the current parameter values in the model calibration parameter vector K. At step S₀, the model calibration parameter vector K may be initialized, for example, using existing parameter values Kᵢₙᵢₜ currently used by the power system operator.

Consistent with the described embodiment, the model approximation engine 404 may use the model calibration vector K to generate a linear system model 406 that approximates the non-linear power system model 402 at least locally around a specified operating point. In other embodiments, the approximated system model may be mildly non-linear (e.g., linear over a practical range) or may be non-linear. The specified operating point around which model is linearized may be chosen as one that defines a steady state of the power system. In this embodiment, the model approximation engine 404 may work with a linear system model given by:

$$\dot{x} = A ( K ) x + B ( K ) u \qquad ( 3 a )$$

$$y = Cx + D u \qquad ( 3 b )$$

where y is a model output signal (e.g., including voltage, frequency, active power, reactive power, etc.), and A, B, C and D are linear function coefficients (e.g., comprising matrices).

The model approximation engine 404 may generate a frequency domain transfer function of the linear system 406 as a function of K as given by:

$$G ( s , K ) = \frac{Y ( s )}{U ( s )} = {C ( sI - A ( K ) )}^{- 1} B ( K ) + D \qquad ( 4 )$$

The model validation engine 408 may be executed to validate the approximated system model generated at each optimization step Sₖ against measurement signals obtained from the actual power system 100. As shown in FIG. 4, the approximated system model may be a linear system model 406 defined by the transfer function G(s, K) determined by the model approximation engine 404. The model validation engine 408 may use the linear system model 406 to transform a dynamic input signal u into a model output signal y′. The model validation engine 408 may compare the model output signal y′ to an actual power system output signal y, obtained from the measurement devices 112, in response to the same dynamic input signal u, to determine a measurement error. The dynamic input signal u may comprise one or more of: reference values, loads and disturbances. The model output signal y′ and the actual power system output signal y may be mapped to a multi-dimensional output space. The output space can be defined by quantities such as frequency, voltage, active power and reactive power, etc.

In the described embodiment, at each optimization step Sₖ, the model validation engine 408 may be used to determine an objective function of the sequential optimization engine 410 by determining an error bound γᵢ in frequency domain. The error bound γᵢ may be determined at each frequency point ωᵢ, over multiple discrete frequency points, based on a norm of the measurement error

E at the respective frequency point ωᵢ. In this case, the input signal u, the model output signal y′ and the actual power system output signal y may be transformed to frequency domain, for example, by applying a Fourier transformation. The model output signal at each frequency point may be represented in frequency domain as:

$${Y}^{′} ( j {ω}_{i} , K ) = G ( j {ω}_{i} , K ) U ( j {ω}_{i} ) \qquad ( 5 )$$

where Y′ and U are Fourier transforms of y′ and u respectively, ωᵢ is the i^{th} frequency point, and j is a complex operator.

The measurement error E at each frequency point ωᵢ may thus be determined as:

$$E ( j {ω}_{i} , K ) = Y ( j {ω}_{i} ) - {Y}^{′} ( j {ω}_{i} , K ) = Y ( j {ω}_{i} ) - G ( j {ω}_{i} , K ) U ( j {ω}_{i} ) \qquad ( 6 )$$

where Y is a Fourier transform of y.

In the described embodiment, a 2-norm measure of a frequency domain integral (summation) of the measurement error is applied to the optimization problem, to minimize the energy of the measurement error in time domain (exploiting Parseval equality). In alternate embodiments, a time domain integral of the measurement error may be utilized in the optimization problem.

Consistent with the described embodiment, the sequential optimization engine 410 may be executed based on an objective function given by:

$${min}_{K} {\sum }_{i} {γ}_{i} ( K ) \qquad ( 7 a )$$

$$s . t . [ \begin{matrix}{γ}_{i} I & Y ( j {ω}_{i} ) - G ( j {ω}_{i} , K ) U ( j {ω}_{i} ) \\ {Y ( j {ω}_{i} )}^{*} - {U ( j {ω}_{i} )}^{*} {G ( j {ω}_{i} , K )}^{*} & {γ}_{i} I\end{matrix} ] > 0 , \qquad ( 7 b )$$

$${γ}_{i} > 0 , {K}_{min} \leq K \leq {K}_{max} \qquad ( 7 c )$$

where γᵢ denotes the error bound at frequency point ωᵢ, I denotes an identity matrix, (*) denotes conjugate operation, and Kₘₐₓ and Kₘᵢₙ denote maximum and minimum parameters values of the model calibration parameters.

Eq. (7a) can ensure that the sequential optimization engine 410, when executed, adjusts the model calibration parameters K always in a direction to minimize the summation of the error bound Yi over multiple discrete frequency points ωᵢ. The optimization may be carried out based on a linear matrix inequality (LMI), such as that specified in eq. (7b). In this example, the LMI in eq. (7b) may be reduced to the following relationship by applying Schur compliment:

$$‖ Y ( j {ω}_{i} ) - G ( j {ω}_{i} , K ) U ( j {ω}_{i} ) {\vert \vert}_{2} \leq {γ}_{i} \qquad ( 8 )$$

In other words, the LMI in eq. (7b) ensures that the error bound γᵢ at each frequency point ωᵢ (RHS) is greater than or equal to a norm (in this case, a 2-norm) of the difference between the actual power system output signal Y(jω_{i.}) and the linear system model output signal Y′(jω_{i.}) at that frequency point ωᵢ (LHS). The summation of the error bound (i.e., Σγᵢ) defines an H₂ norm, which may define an objective function to be minimized by the sequential optimization engine 410.

In an alternate embodiment, a H_{∞} optimization method may be used, where a maximum of the error bound over the multiple frequency points may be determined as the H_{∞} norm, which may define the objective function to be minimized by the sequential optimization engine 410. The LMI may be accordingly formulated based on a H_{∞} optimization framework.

Eq. (7c) specifies optimization constraints, that include a positivity constraint of the error bound γᵢ and the maximum and minimum values of the model calibration parameters K.

At each optimization step Sₖ, the sequential optimization engine 410 may execute a sequential convex optimization algorithm utilizing an LMI solver, based on the error bound, the LMI framework and the specified constraints, to determine adjusted parameter values K of the model calibration parameters. Consistent with the described embodiment, the sequential optimization engine 410 may adjust the parameter values K in a direction to minimize the H₂ norm. In an alternate embodiment, as stated above, the sequential optimization engine 410 may be configured to adjust the values K in a direction to minimize a H_{∞} norm.

The adjusted model calibration parameter values K may then form a new design point for the model approximation engine 404 to generate an approximated (e.g., linearized) system model 406, based on the power system model 402, for the next optimization step Sₖ₊₁. Optimal values of the model calibration parameters K may be obtained by iteratively executing the steps of model approximation, validation with measurement signals and parameter tuning by sequential optimization, until a convergence criterion is satisfied. The convergence criterion may be based, for example, on a threshold difference between the parameter values K between consecutive optimization steps. Alternately, the convergence criterion may specify the number of optimization steps to be executed. The resulting optimal parameter values Kₒₚₜ of the model calibration parameters may be transferred to the power system model 402 (e.g., eq.(2a) and (2b)), to thereby calibrate the power system model 402 against the power system 100.

In a further aspect, the power system model 402, which may be calibrated by any of the disclosed embodiments, may be used to control the power system 100. The calibrated power system model 402 may be used to run simulations to predict a response of the power system 100 to one or multiple input scenarios (e.g., including grid disturbances, power network contingencies, etc.). Simulations using the calibrated power system model may be used, for example, for setting power system operating limits, based on which one or more controllers of the generator subsystems 106 may be controlled using control signals (e.g. from a centralized grid control system) to generate real time control actions. The control actions can include controlling one or more electrical quantities assorted with the generator subsystems 106, such terminal voltage, frequency, active power, etc. As examples, the control actions may be configured to maintain reliable operation of the various generator subsystems 106 under uncertainties in load and/or infeed power, to maintain dynamic security of the power system 100 in the event of a dropout of a power plant, and so forth.

FIG. 5 shows an example of a computing system 500 that supports online calibration of a power system model according to the present disclosure. The computing system 500 may form part of a model calibration system, such as the model calibration system 110. The computing system 500 includes at least one processor 510, which may take the form of a single or multiple processors. The processor(s) 510 may include a central processing unit (CPU), a graphics processing unit (GPU), a microprocessor, or any hardware device suitable for executing instructions stored on a memory comprising a machine-readable medium. The computing system 500 further includes a machine-readable medium 520. The machine-readable medium 520 may take the form of any non-transitory electronic, magnetic, optical, or other physical storage device that stores executable instructions, such as model approximating instructions 522, model validating instructions 524 and sequential optimization instructions 526, as shown in FIG. 5. As such, the machine-readable medium 520 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 500 may execute instructions stored on the machine-readable medium 520 through the processor(s) 510. Executing the instructions (e.g., the model approximating instructions 522, the model validating instructions 524 and the sequential optimization instructions 526) may cause the computing system 500 to perform any of the technical features described herein, including according to any of the features of the model approximation engine 404, the model validation engine 408 and the sequential optimization engine 410 described above.

The systems, methods, devices, and logic described above, including the model approximation engine 404, the model validation engine 408 and the sequential optimization engine 410, may be implemented in many different ways in many different combinations of hardware, logic, circuitry, and executable instructions stored on a machine-readable medium. For example, these engines may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the model approximation engine 404, the model validation engine 408 and the sequential optimization engine 410. Computer readable program instructions described herein can be downloaded to respective computing/processing devices from a computer readable storage medium or to an external computer or external storage device via a network, for example, the Internet, a local area network, a wide area network and/or a wireless network.

The processing capability of the systems, devices, and engines described herein, including the model approximation engine 404, the model validation engine 408 and the sequential optimization engine 410 may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

1. A computer-implemented method for online calibration of a power system model against a power system having one or more active generator subsystems connected to a power network and a number of measurement devices installed in the power network to dynamically measure electrical quantities associated with each of the active generator subsystems, the method comprising:
iteratively performing, over a series of steps:
executing a model approximation engine by one or more processors to generate a system model that approximates the power system model, based on current parameter values of a set of model calibration parameters,
executing a model validation engine by the one or more processors for:
using the generated system model to transform a dynamic input signal into a model output signal, and
obtaining measurement signals from the measurement devices that define an actual power system output signal generated in response to the dynamic input signal, and
executing a sequential optimization engine by the one or more processors to adjust parameter values of the model calibration parameters in a direction to minimize an error between the model output signal and the actual power system output signal,
whereby, the power system model is calibrated against the power system based on resulting optimal values of the model calibration parameters.

2. The method according to claim 1,
wherein each active generator subsystem of the power system comprises a generator and one or more controllers, and
wherein the model calibration parameters comprise physical parameters of the generator subsystems and/or controller parameters of the controllers of the generator subsystems.

3. The method according to claim 2, wherein the one or more controllers are selected from the set consisting of: governor, power system stabilizer, exciter and voltage regulator.

4. The method according to claim 1, comprising executing a sensitivity analysis engine by the one or more processors to select the model calibration parameters as a subset out of a set of system parameters of the power system model by determining a sensitivity index of individual system parameters.

5. The method according to claim 4, wherein the sensitivity index of individual system parameters are determined by:
for each system parameter in the set of system parameters, running simulations using a linear system model of the power system for M different values of each system parameter keeping the remaining system parameters fixed, wherein the M different values are distributed within a stable range of the respective system parameter, and
determining the sensitivity index at each value of an individual system parameter by measuring an averaged time domain error between a model output Yₗᵢₙₑₐᵣ of the linear system model and an actual power system output Y_{Measured} obtained from the measurement devices, as given by:
$$S . I . = \frac{1}{N} {\sum }_{{T}_{υ}}^{p = 1 , 2 , … , N} \vert {Y}_{Measured} ( {T}_{p} ) - {Y}_{linear} ( {T}_{p} ) \vert ,$$
where Tₚ denotes time steps, N denotes the total number of time steps.

6. The method according to claim 1, wherein the dynamic input signal comprises one or more of: reference values, loads and disturbances.

7. The method according to claim 1, wherein the model output signal and the actual power system output signal are each mapped to a multi-dimensional output space, wherein the output space is defined by quantities selected from the group consisting of: frequency, voltage, active power and reactive power.

8. The method according to claim 1, wherein the system model generated at each step is a linear system model that at least locally approximates the power system model around a specified operating point.

9. The method according to claim 8, wherein the linear system model is generated at each step by determining a frequency domain linear transfer function G(s, K), where K is a calibration parameter vector representing current parameter values of the model calibration parameters at that step.

10. The method according to claim 9, wherein the error to be minimized is determined by:
transforming the output signal and the actual power system output signal to frequency domain, and
determining an error bound at each of multiple discrete frequency points, the error bound being determined based on a norm of a difference between the actual power system output signal and the model output signal at the respective frequency point

11. The method according to claim 10, wherein a summation of the error bound over the multiple frequency points is determined as an H₂ norm, and wherein the sequential optimization engine is executed to adjust the parameter values of the model calibration parameters in a direction to minimize the H₂ norm.

12. The method according to claim 10, wherein a maximum of the error bound over the multiple frequency points is determined as an H_{∞} norm, and wherein the sequential optimization engine is executed to adjust the parameter values of the model calibration parameters in a direction to minimize the H_{∞} norm.

13. A method for controlling a power system, comprising:
calibrating a power system model against the power system by a method according to
running simulations using the calibrated power system model to predict a response of the power system to one or multiple input scenarios, and
controlling one or more generator subsystems of the power system via controllers of the generator subsystems by generating control actions determined based on the simulations using the calibrated power system model.

14. A non-transitory computer-readable storage medium including instructions that, when processed by a computing system, configure the computing system to perform the method according to claim 1.

15. A power system comprising:
one or more active generator subsystems connected to a power network,
a number of measurement devices installed in the power network to dynamically measure electrical quantities associated with each of the active generator subsystems, and
a model calibration system for calibrating a power system model against the power system, the model calibration system comprising:
one or more processors, and
a memory storing algorithmic modules executable by the one or more processors, the algorithmic modules comprising:
a model approximation engine configured, at each step in a series of steps, to generate a system model that approximates the power system model, based on current parameter values of a set of model calibration parameters,
a model validation engine configured to, at each step:
use the generated system model to transform a dynamic input signal into a model output signal, and
obtain measurement signals from the measurement devices that define an actual power system output signal generated in response to the dynamic input signal, and
a sequential optimization engine configured, at each step, to adjust parameter values of the model calibration parameters in a direction to minimize an error between the model output signal and the actual power system output signal,
whereby, the power system model is calibrated against the power system based on optimal values of the model calibration parameters obtained by iteratively executing the series of the steps by the one or more processors.
